(19) United States
(12) Patent Application Publication
(10) Pub. No.: US 2025/0073879 A1
(43) Pub. Date: Mar. 6, 2025

(54) CROWBAR FOR PULLING A PLASTIC NAIL

(71) Applicant: COMLOCK ENTERPRISE CO., LTD., Taichung City (TW)

(72) Inventor: NIAN-HAO LIAO, Taichung City (TW)

(21) Appl. No.: 18/239,760

(22) Filed: Aug. 30, 2023

(51) Int. Cl. B25C 11/00

(52) U.S. Cl. CPC B25C 11/00

(57) ABSTRACT

A crowbar includes a grip, a bar and an auxiliary element. The bar includes a connective portion connected to the grip, a bifurcated end extending opposite to the connective portion, and a bent portion extending between the bifurcated end and the connective portion. The auxiliary element is connected to the grip so that the auxiliary element is pivotable into contact with the bar.

### BACKGROUND OF INVENTION

### 1. Field of Invention

The present invention relates to a plastic nail and, more particularly, to a crowbar for pulling a plastic nail.

### 2. Related Prior Art

A plastic nail is used to interconnect two objects. For example, a plastic nail is operable to connect a carpet to a chassis of a vehicle or a decorative panel to a door of a vehicle.

Taiwanese Patent No. 1777619 discloses a puller including two levers 12 pivotally connected to a grip 10. A spring 17 biases the levers 12 from each other. Each of the levers 12 includes a bifurcated end 15 transversely extending from a free end.

In operation, the bifurcated ends 15 are brought into contact with a head of a plastic nail 81. The puller is used to pull the plastic nail 81 from an expansible sleeve 82 (FIGS. 8 and 9). Alternatively, the puller is used like a crossbar to pull the plastic nail 81 from the expansible sleeve 82 (FIGS. 10 through 12).

The bifurcated ends 15 must be opened to render the distance between them larger than a diameter of the head of the plastic nail 81. This however causes some problems.

Firstly, the plastic nail 81 is sometimes located in a deeper pothole. A diameter of the deeper pothole is sometimes a little larger than the smallest distance between external faces 142 of the levers 12 so that the bifurcated ends 15 cannot be opened adequately to bring the bifurcated ends 15 into contact with the head of the plastic nail 81 although the bifurcated ends 15 can be located in the deeper pothole.

In the worst case, the diameter of the deeper pothole is smaller than the smallest distance between external faces 142 of the levers 12 so that the bifurcated ends 15 cannot be even inserted in the deeper pothole to clamp the plastic nail 81.

The present invention is therefore intended to obviate or at least alleviate the problems encountered in the prior art.

### SUMMARY OF INVENTION

It is the primary objective of the present invention to provide a reliable crowbar.

To achieve the foregoing objective, the crowbar includes a grip, a bar and an auxiliary element. The bar includes a connective portion connected to the grip, a bifurcated end extending opposite to the connective portion, and a bent portion extending between the bifurcated end and the connective portion. The auxiliary element is connected to the grip so that the auxiliary element is pivotable into contact with the bar.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a crowbar according to the preferred embodiment of the present invention;

FIG. 2 is another perspective view of the crowbar shown in FIG. 1;

FIG. 3 is a cross-sectional view of the crowbar shown in FIG. 1;

FIG. 4 is a side view of a nail to be removed from a pothole with the crowbar shown in FIG. 1; and

FIG. 5 is a side view of a nail to be removed from a deeper pothole with the crowbar shown in FIG. 1.

### DETAILED DESCRIPTION OF PREFERRED EMBODIMENT

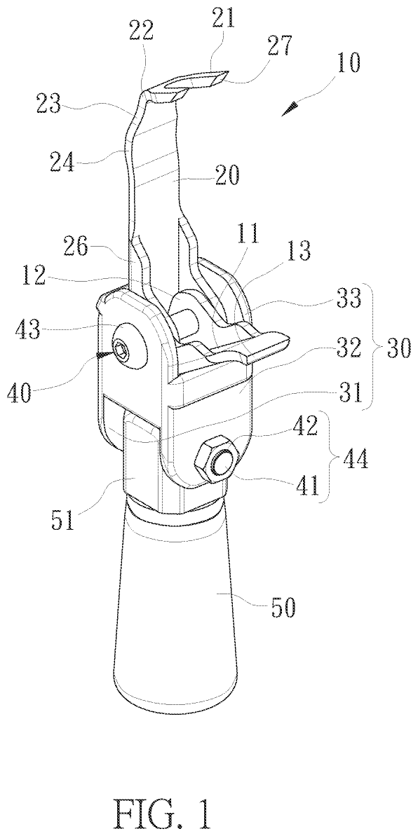

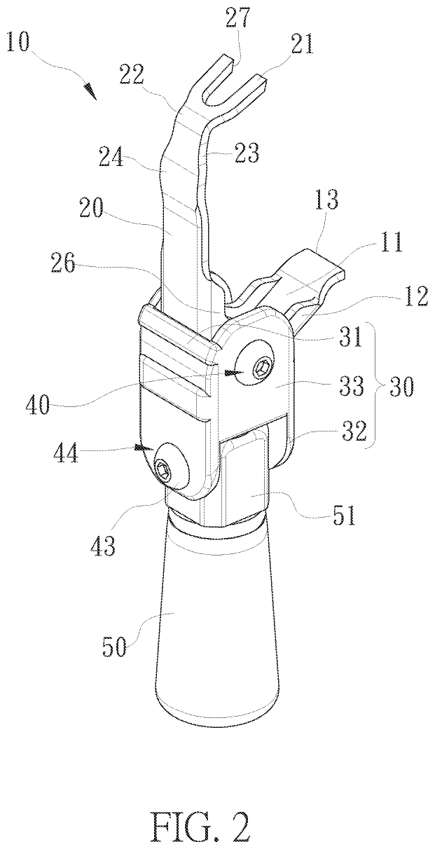

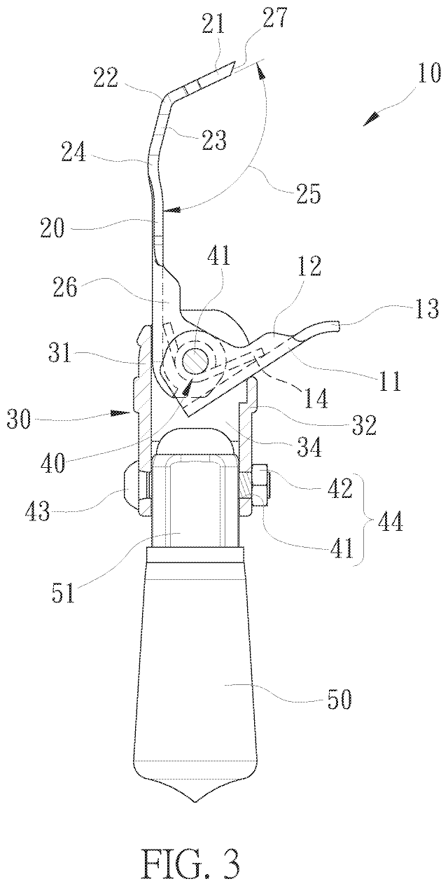

Referring to FIGS. 1 to 3, a crowbar 10 include an auxiliary element 11, a bar 20, a connector 30, two fasteners 40 and 44 and a grip 50 according to the preferred embodiment of the present invention. The bar 20 is connected to the connector 30 with the fastener 40. The grip 50 is connected to the connector 30 with the fastener 44.

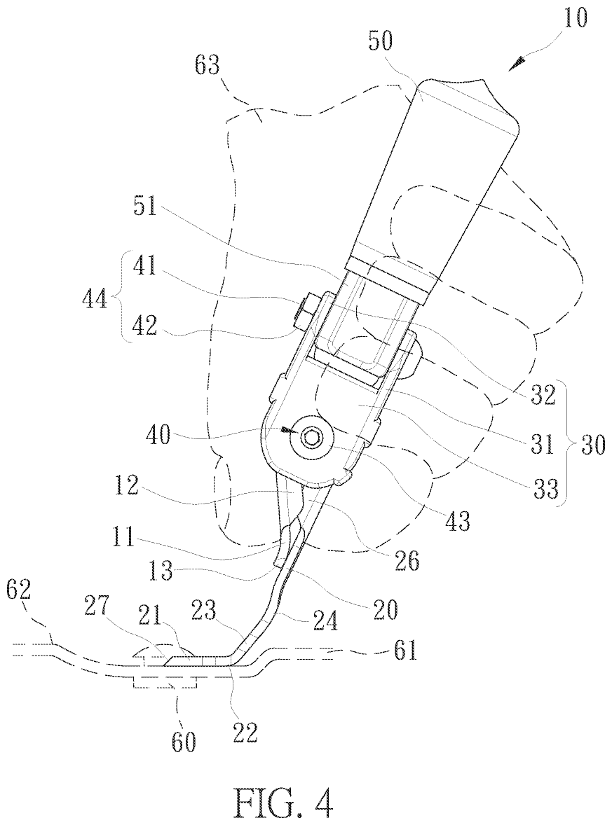

The bar 20 is a long thin element preferably made of metal. A first end of the bar 20 (front lower end in operation) is a bifurcated end 21. The bifurcated end 21 includes two prongs 27 separated by a gap (not numbered) wider than a diameter of a plastic nail 60 (FIG. 4). Each of the prongs 27 is shaped like a ramp.

There is an angle 25 between the bifurcated end 21 and the remaining portion of the bar 20. Preferably, the angle 25 is 95 to 145 degrees and, more preferably, 105 degrees to 135 degrees.

Preferably, the bar 20 includes a slant portion 23 extending between two bent portions 22 and 24. The bent portion 22 is formed between the bifurcated end 21 and the slant portion 23. The bent portion 24 is formed between the slant portion 23 and a root (not numbered) of the bar 20 which is connected to the grip 50.

However, in another embodiment, the slant portion 23 and the bent portion 24 are omitted. That is, there is only a bent portion, i.e., the bent portion 22, between the bifurcated end 21 and the root of the bar 20.

As discussed above, there can be one bent portion or more between the bifurcated end 21 and the root of the bar 20 for providing the crowbar with adequate strength. However, the number of the bent portion(s) between the bifurcated end 21 and the root of the bar 20 does not influence the angle 25.

The bar 20 further includes two lugs 26 extending along two opposite edges. The lugs 26 are in vicinity of a second end of the bar 20 (rear upper end in operation). The lugs 26 are identical to each other in shape.

Preferably, the connector 30 includes two lateral plates 33 formed between a rear plate 31 and a front plate 32, thereby providing a chamber 34. The rear plate 31 extends longer than the front plate 32. The lateral plates 33 are identical to each other.

Preferably, each of the fasteners 40 and 44 includes a threaded bolt 41 engaged with a nut 42. The threaded bolt 41 includes a head 43. In another embodiment, each of the fasteners 40 and 44 includes a rivet instead of the combination of the threaded bolt 41 with the nut 42.

The threaded bolt 41 of the fastener 40 is inserted in the lugs 26 of the bar 20 and the lateral plates 33 of the connector 30 as the second end of the bar 20 is located in the chamber 34. The lugs 26, which are identical to each other, extend along two opposite edges of the bar 20. The bar 20 is in contact with the rear plate 31 of the connector 30 so that the former is not expected to pivot relative to the later. The head 43 of the threaded bolt 41 of the second fastener is in contact with one of the lateral plates 33, and the nut 42 is in contact with the remaining one of the lateral plates 33.

The auxiliary element 11 is also a thin element preferably made of metal. The auxiliary element 11 includes two lugs 12 and an arched portion 13. The lugs 12 extend along two opposite edges of the auxiliary element 11. The arched portion 13 extends from an end of the auxiliary element 11. The lugs 12 are identical to each other in shape. The threaded bolt 41 of the fastener 40 is inserted in the lugs 12 of the auxiliary element 11, thereby allowing the auxiliary element 11 to pivot relative to the connector 30. Preferably, the lugs 12 of the auxiliary element 11 are located between the lugs 26 of the bar 20.

A torque spring 14 is operable to bias the auxiliary element 11 from the bar 20. To this end, the torque spring 14 includes a helical middle section extending around the threaded bolt 41 of the fastener 40, a rectilinear terminal section in contact with the auxiliary element 11 and another rectilinear terminal section in contact with the bar 20. Thus, the auxiliary element 11 is abutted against an edge of the front plate 32, and the bar 20 is abutted against the rear plate 31.

The threaded bolt 41 of the fastener 44 is inserted in a supporting element 51 of the grip 50 and the front and rear plates 32 and 31 of the connector 30. The head 43 of the threaded bolt 41 of the fastener 44 is in contact with the rear plate 31 (or the front plate 32) of the connector 30, and the nut 42 of the fastener 44 is in contact with the front plate 32 (or the rear plate 31). The connector 30 is allowed to pivot relative to the grip 50.

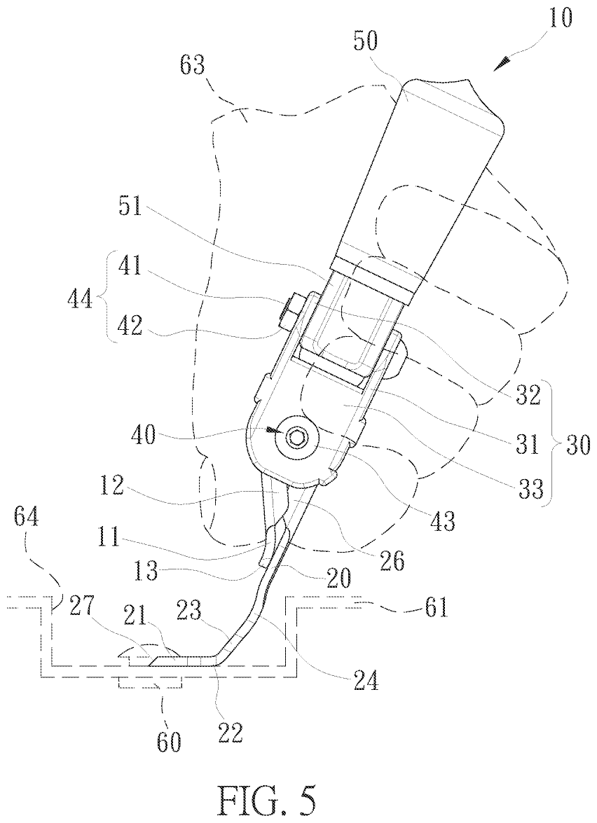

Referring to FIGS. 4 and 5, the crowbar is operable to pull a plastic nail 60 from a flat object 61. The plastic nail 60 includes a head (not numbered) located in a shallow pothole 62 (FIG. 4) or a deep pothole 64 (FIG. 5) made in the flat object 61. The head of the plastic nail 60 is in contact with a portion of the flat object 61 in the pothole 62 or 64.

To this end, a user uses a hand 63 to hold the grip 50 to insert the bifurcated end 21 of the bar 20 in the pothole 62 or 64. The ramp-like prongs 27 of the bifurcated end 21 of the bar 20 render it easy to squeeze the bifurcated end 21 of the bar 20 in a gap (not numbered) between the head of the plastic nail 60 and the flat object 61. Finally, the bifurcated end 22 of the bar 20 is properly located beneath the head of the plastic nail 60. The bar 20 is pivoted about the bent portion 23 thereof, which is abutted against the flat object 61. Thus, the plastic nail 60 is pulled from the flat object 61.

The arched portion 13 of the auxiliary element 11 is used for contact with the thumb of the hand 63. Thus, the thumb is not pressed against the lugs of the bar 20. Hence, the user does not feel pain in the thumb while using the crowbar.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A crowbar comprising:
a grip;
a bar comprising:
a connective portion connected to the grip;
a bifurcated end extending opposite to the connective portion; and
a bent portion extending between the bifurcated end and the connective portion at an angle; and
an auxiliary element connected to the grip so that the auxiliary element is pivotable into contact with the bar.

2. The crowbar according to claim 1, wherein the auxiliary element comprises an arched portion for contact with the bar.

3. The crowbar according to claim 1, wherein the angle is 95 to 145 degrees.

4. The crowbar according to claim 1, wherein the angle is 105 to 135 degrees.

5. The crowbar according to claim 1, comprising a connector for connecting the grip to the auxiliary element and the bar.

6. The crowbar according to claim 5, comprising a first fastener for connecting the connector to the auxiliary element and the bar and a second fastener for connecting the connector to the grip.

7. The crowbar according to claim 6, wherein the connector comprises a rear plate, a front plate and two lateral plates formed between the rear and front plates, wherein the first fastener is connected to the lateral plates, wherein the second fastener is connected to the rear and front plates.

8. A crowbar comprising:
a grip; and
a bar comprising:
a connective portion connected to the grip;
a bifurcated end; and
a bent portion extending between the bifurcated end and the connective portion at an angle.

9. The crowbar according to claim 8, the angle is 95 to 145 degrees.

10. The crowbar according to claim 8, the angle is 105 to 135 degrees.

11. The crowbar according to claim 8, comprising a connector for connecting the grip to the auxiliary element and the bar.

12. The crowbar according to claim 11, comprising a first fastener for connecting the connector to the auxiliary element and the bar and a second fastener for connecting the connector to the grip.

13. The crowbar according to claim 12, wherein the connector comprises a rear plate, a front plate and two lateral plates formed between the rear and front plates, wherein the first fastener is connected to the lateral plates, wherein the second fastener is connected to the rear and front plates.

14. A crowbar comprising:
a grip;
a bifurcated end; and
a bent portion extending between the grip and the bifurcated end at an angle.

15. The crowbar according to claim 14, wherein the angle is 95 degrees to 145 degrees.

16. The crowbar according to claim 14, wherein the angle is 105 degrees to 135 degrees.
